(19) United States
(12) Patent Application Publication
(10) Pub. No.: US 2026/0208025 A1
(43) Pub. Date: Jul. 23, 2026

(54) TRAINING APPARATUS, METHOD AND PROGRAM

(71) Applicant: NIPPON TELEGRAPH AND TELEPHONE CORPORATION, Tokyo (JP)

(72) Inventors: Toshitaka KIMURA, Tokyo (JP); Katsutoshi MASAI, Tokyo (JP); Akemi KOBAYASHI, Tokyo (JP)

(73) Assignee: NIPPON TELEGRAPH AND TELEPHONE CORPORATION, Tokyo (JP)

(21) Appl. No.: 18/718,773

(22) PCT Filed: Dec. 17, 2021
(86) PCT No.: PCT/JP2021/046785

§ 371 Date: Jun. 11, 2024

(51) Int. Cl. A63B 71/06; A63B 24/00; G06F 3/01; G06T 11/00; G06T 13/00

(52) U.S. Cl. CPC A63B 71/0622; A63B 24/0062; G06F 3/013; G06T 11/00; G06T 13/00; A63B 2024/0065; A63B 2071/0638; A63B 2214/00; A63B 2220/807; A63B 2220/836

(57) ABSTRACT

A training device includes a storage unit 1 that stores video information corresponding to setting of each video, a setting unit 2 that sets video setting information that is information for specifying the setting of the video, a video synthesis unit 3 that synthesizes virtual video in which a subject is reflected by using exercise information of the subject and the video information corresponding to the video setting information read from the storage unit 1, and a video presentation unit 4 that presents the virtual video to the subject. The video synthesis unit 3 delays a movement of the subject in the virtual video on the basis of the movement of a line of sight acquired from a sensor attached to the subject.

### TECHNICAL FIELD

The present invention relates to a technique for improving exercise ability of a subject.

### BACKGROUND ART

As the technique for improving the exercise ability of the subject, a technique disclosed in PTL 1 is known.

A training device described in PTL 1 includes a storage unit that stores movement information used when presenting a movement of an object as video and attention exercise type information that is information in which change exercise type information representing a type of exercise information having a difference between a exercise with high evaluation and an exercise with low evaluation on the exercise and attention visual information that is information for specifying an attention region and attention time point in virtual video are associated, a training condition setting unit that outputs the attention visual information associated with the change exercise type information corresponding to training target exercise information on the basis of the attention exercise type information when the training target exercise information that is a type of exercise for training the training subject, and a second video synthesis unit that synthesizes the virtual video presenting an environment which cannot be reproduced in a real environment by using the movement information, wherein the second video synthesis unit synthesizes, in the vicinity of attention time point included in the attention visual information in the virtual video, the virtual video on which visual effect emphasizing a attention region specified by the attention visual information is superimposed.

Thus, the subject can perform training so that the subject can handle the perception information by using the perception information having a large contribution to the exercise control.

### CITATION LIST

### Patent Literature

[PTL 1] Japanese Patent Application Publication No. 2019-42219

### SUMMARY OF INVENTION

### Technical Problem

In the training device disclosed in PTL 1, training that can be performed is limited.

An object of the present invention is to provide a training device, a training method, and a program that enable training that cannot be performed by a training device of PTL 1.

### Solution to Problem

In order to solve the above problem, a training device according to an aspect of the present invention includes a storage unit that stores video information corresponding to setting of each video, a setting unit that sets video setting information that is information for specifying the setting of the video, a video synthesis unit that synthesizes virtual video in which a subject is reflected by using exercise information of the subject and the video information corresponding to the video setting information read from the storage unit, and a video presentation unit that presents the virtual video to the subject, wherein the video synthesis unit delays a movement of the subject in the virtual video on the basis of the movement of a line of sight acquired from a sensor attached to the subject.

### Advantageous Effects of Invention

The training which cannot be performed in the training device of PTL 1 can be performed,

### BRIEF DESCRIPTION OF DRAWINGS

FIG. 1 is a diagram showing an example of a functional configuration of a training device.

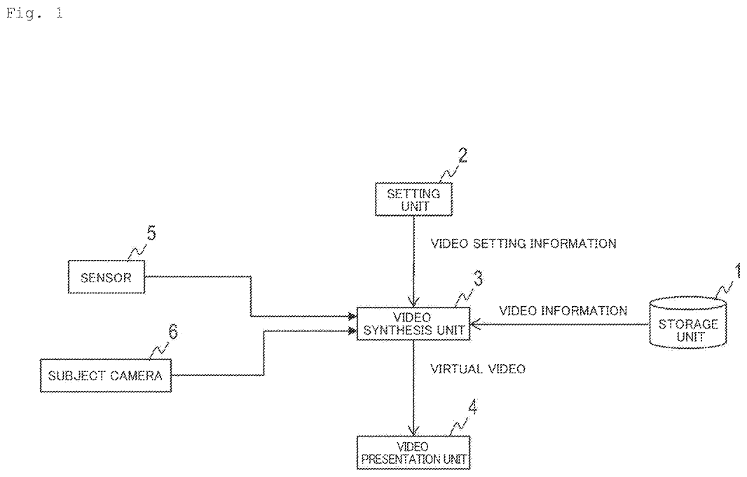

FIG. 2 is a diagram showing an example of a processing procedure of a training method.

FIG. 3 is a diagram showing a functional configuration example of a computer.

### DESCRIPTION OF EMBODIMENTS

Hereinafter, embodiments of the present invention will be described. Note that identical reference numerals are used for constituent units having identical functions and steps in which identical processing is performed, and duplicate description thereof will be omitted.

The training device includes a storage unit 1, a setting unit 2, a video synthesis unit 3, and a video presentation unit 4.

The training device may include a sensor 5 for acquiring a movement of a line of sight of a training subject and a subject camera 6 for acquiring exercise information of the subject.

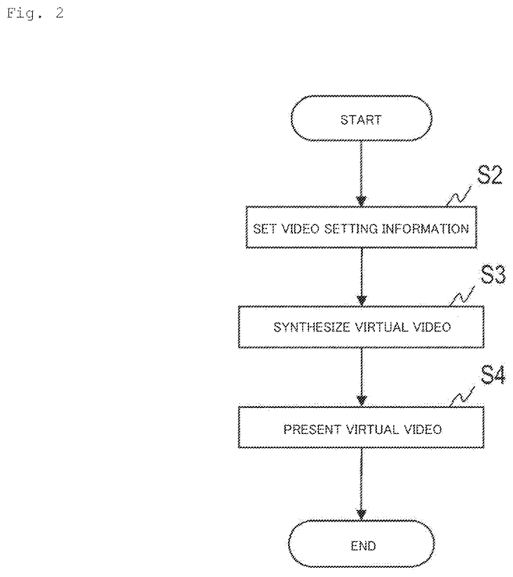

A training method is realized, for example, by causing each constituent unit of the training device to perform processing from step S2 to step S4 described below and shown in FIG. 2.

The training device and method will be described below by taking the training of baseball batting as an example. However, the user of the training device and method is not limited to the training of baseball batting. The training device and method may be used for training of other competitions. Examples of other competitions are interpersonal ball games such as softball, tennis, and table tennis, and competition such as badminton, in which the roles of serving (throwing) and receiving (hitting back) are defined.

Each constituent unit of the training device will be described below.

### Storage Unit 1

The storage unit 1 stores video information corresponding to setting of each video. The video information may be literal video information or information necessary for generating virtual video to be described later.

An example of the setting of the video is setting of a movement of an object appearing in the video.

For example, when the training of baseball batting is performed, the setting of the movement of the object is at least one of (1) the setting of the movement of the pitcher and (2) the setting of the movement of the ball.

(1) The setting of the movement of the pitcher can be said to be the setting of the ball type thrown by the pitcher.

The video information of the movement of the pitcher corresponding to each ball type is stored in the storage unit 1. For example, the video information of the movement of the over-hand throw pitcher corresponding to the ball type of straight, the video information of the movement of the side throw pitcher throwing a curve, and the video information of the movement of the under-hand throw pitcher throwing a slider are stored in the storage unit 1.

(2) The setting of the movement of the ball can be also said to be the setting of the ball type.

A series of position information of the ball corresponding to each ball type is stored. in the storage unit 1. For example, a series of position information of straight balls, a series of position information of curved balls, and a series of position information of slider balls are stored in the storage unit 1.

The series of position information of the ball is information indicating the position of the ball at each time point t=(Tstart, Tstart+1, . . . , Tstart+Tc) in a time interval range from the time point Fstart at which the ball leaves a hand of the pitcher until predetermined time interval Tc elapses. The time point here may be a frame number.

The setting of the video may include the setting of the video environment, The video environment is, for example, clear, rainy, bright, or dark.

### Setting Unit 2

The setting unit 2 sets video setting information that is information for specifying the setting of the video (step S2).

The set video setting information is outputted to the video synthesis unit 3.

The setting unit 2 may set the video setting information at random or may set the video setting information on the basis of a predetermined reference.

Further, the setting unit 2 may set the video setting information inputted by a user of the training device and method by using an input device such as a mouse, a keyboard, a touch pad, or the like. Examples of users of the training device and method are subjects of the training performed by the training device and method.

The video setting information may include two or more pieces of information for specifying the setting of the video. For example, the setting unit 2 may set the video setting information of (movement of pitcher, movement of ball)=(straight, straight).

The setting unit 2 may set the video setting information in which the ball type corresponding to the movement of the pitcher and the ball type corresponding to the movement of the ball are different from each other, such as (movement of pitcher, movement of ball)=(straight, curve).

As in this example, when the video setting information is information of (movement of pitcher, movement of ball)=(straight, curve), the video presented by the video presentation unit 4 to be described later is video of a situation in which the pitcher throws straight, but the thrown ball moves along the trajectory of the curve, which cannot occur in reality.

Thus, the video setting information in which the ball type corresponding to the movement of the pitcher and the ball type corresponding to the movement of the ball are different can be set, so that the training for coping with the situation which cannot occur in reality can be performed.

### Video Synthesis Unit 3

The video setting information set by the setting unit 2 is inputted to the video synthesis unit 3.

In addition, the exercise information of the subject acquired by the subject camera 6 is inputted to the video synthesis unit 3.

Further, the movement of the line of sight of the subject acquired by the sensor 5 is inputted to the video synthesis unit 3.

The video synthesis unit 3 synthesize virtual video in which the subject is reflected by using the exercise information of the subject and the video information corresponding to the video setting information read from the storage unit 1 (step S3).

At this time, the video synthesis unit 3 delays the movement of the subject in the virtual video on the basis of the movement of the line of sight acquired from the sensor 5 attached to the subject.

The synthesized virtual video is outputted to the video presentation unit 4.

The exercise information of the subject is, for example, a three-dimensional position of a marker attached to a body of the subject, which is generated by optical motion capture using the subject cameras 6 which are a plurality of cameras. In this case, the movement of the subject is represented by an avatar.

The exercise information of the subject may be the video information of the subject photographed by the subject camera 6. In this case, the virtual video is synthesized by using the actual video information of the subject.

The video synthesis unit 3 reads the video information corresponding to the video setting information set by the setting unit 2 from the storage unit 1.

For example, when the video setting information of (movement of pitcher, movement of ball)=(straight, straight) is set, the video synthesis unit 3 reads the video information of the movement of the over hand throw pitcher corresponding to the ball type of straight and the series of position information of the straight ball from the storage unit 1.

The sensor 5 may be directly attached to the subject or indirectly attached to the subject. The sensor 5 is attached to, for example, a head-mounted display worn by the subject.

The sensor 5 may be a line of sight measurement device independent of the head-mounted display and not built in the head-mounted display.

The video synthesis unit 3 delays the movement of the subject in the virtual video on the basis of the movement of the line of sight of the subject acquired from the sensor 5 attached to the subject.

Examples of the movement of the line of sight are a locus of the line of sight and a locus of the point of sight. The locus of the line of sight is a locus of a direction of viewing. The locus of the point of sight is a locus of a position of viewing.

An example of delaying the movement of the subject in the virtual video on the basis of the movement of the line of sight of the subject will be described below.

First, the video synthesis unit 3 determines whether the movement of the line of sight of the subject acquired by the sensor 5 becomes larger than a predetermined threshold value. The predetermined threshold value is a value predetermined so as to obtain a desired result.

When the subject tracks the thrown ball and a predictive saccade which flies the line of sight to a hitting point predicted therefrom occurs or the magnitude of deviation of the line of sight by the predictive saccade is larger than a predetermined magnitude, the video synthesis unit 3 may determine that the movement of the line of sight becomes larger than the predetermined threshold value.

In addition, when a catch-up saccade which flies the line of sight to quickly track the ball occurs when the ball is thrown, or when the magnitude of deviation of the line of sight by the catch-up saccade is larger than the predetermined magnitude, the video synthesis unit 3 may determine that the movement of the line of sight becomes larger than the predetermined threshold value.

When the movement of the line of sight becomes larger than the predetermined threshold value, the video synthesis unit 3 delays the movement of the subject in the virtual video. For example, when the batting training is performed, the rotation speed of the bat swing of the subject in the virtual video is reduced.

Note that when the movement of the line of sight is larger than the predetermined threshold value, the video synthesis unit 3 may delay the movement of the subject in the virtual video more largely as the predetermined threshold value is smaller.

In the case of a skilled person of batting, the time interval required for determining the thrown ball is long. This is because the skilled person of batting delays the bat swing until the very last possible moment to identify the thrown ball.

On the other hand, in the case of an unskilled person in batting, the time interval for determining the thrown ball is shorter than the time interval for determining the thrown ball by the skilled person.

Therefore, in order to make the subject who is the unskilled person in batting resemble the batting of the skilled person, it is recommended to make the subject realize that the slower timing of swinging the bat is preferable by showing the virtual video obtained by delaying the movement of the subject to the subject when the time interval for determining the thrown ball is short, in other words, that the time interval for determining the thrown ball could be longer.

Here, the time interval for determining the thrown ball can be considered to be the time interval until the movement of the line of sight becomes larger than the predetermined threshold value. Therefore, when the movement of the line of sight becomes larger than the predetermined threshold value, the video synthesis unit 3 considers that the subject has determined the thrown ball, and delays the movement of the subject in the virtual video.

Note that the video synthesis unit 3 may change a delay amount of the movement of the subject in the virtual video in accordance with at least one of the passage of time interval and an action of the subject.

For example, the video synthesis unit 3 may reduce the delay amount of the movement of the subject in the virtual video in accordance with passage of time interval, and may make the delay amount of the movement of the subject zero at the timing when the bat and the ball contact each other.

The delay amount of the movement of the subject is set to zero at the timing when the bat and the ball contact each other, thereby reducing the sense of discomfort that the subject may feel.

Note that a person other than the training subject may be reflected in the virtual video. An example of the person other than the subject is a pitcher.

### Video Presentation Unit 4

The virtual video synthesized by the video synthesis unit 3 is inputted to the video presentation unit 4.

The video presentation unit 4 presents the virtual video to the subject (step S4).

The video presentation unit 4 is, for example, the head-mounted display worn by the subject. The video presentation unit 4 may use a display such as a liquid crystal display, an organic EL display, a micro LED display, a video projector, a cathode-ray tube, or a plasma display.

As described above, by presenting the virtual video obtained by delaying the movement of the subject on the basis of the movement of the line of sight acquired from the sensor attached to the training subject, the training which cannot be performed conventionally can be performed.

### Modification Example

While embodiments of the present invention have been described above, specific configurations are not limited to the embodiments and, needless to say, the present invention also includes appropriate changes in design or the like having been made without departing from the spirit and the scope of the present invention.

The various types of processing described in the embodiments are not limited to being executed in a time series manner in the described order, and may be executed in parallel or individually in accordance with the processing capability of the device that executes the processing or as required.

For example, data may be directly exchanged between the constituent units of the training device or may be exchanged via a storage unit not shown.

In addition, the predetermined threshold value used in the processing of the video synthesis unit 3 may be set by a user of the training device and method by using an input device such as a mouse, a keyboard, a touch pad. Thus, the user of the training device and method can set the predetermined threshold value to a desired value. Then, the convenience of the training device and method is improved.

Note that the video synthesis unit 3 may accelerate the movement of the subject in the virtual video on the basis of the movement of the line of sight acquired from the sensor 5 attached to the subject.

### Program, Recording Medium

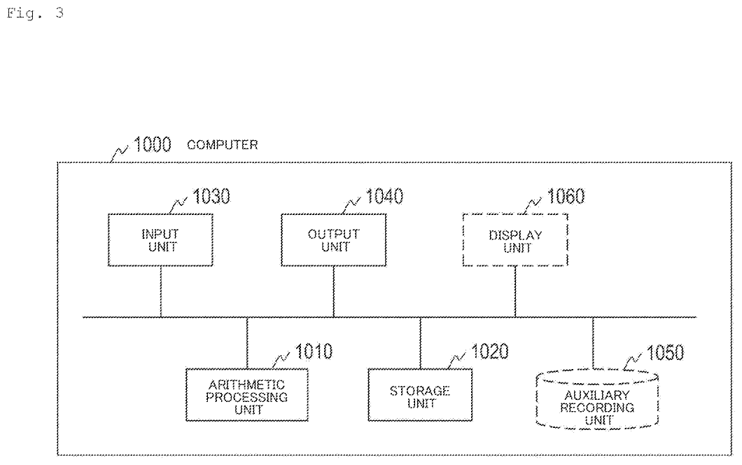

The processing of each unit of each device described above may be realized by a computer. In this case, the processing contents of the functions to be possessed by each device are written in a program. Then, the various types of processing functions of each device are realized on the computer, by causing the computer to read this program in a storage unit 1020 of a computer 1000 shown in FIG. 3, and to operate an arithmetic processing unit 1010, an input unit 1030, an output unit 1040, and the like. The computer 1000 may include the display unit 1060.

The program describing these processing contents can be recorded on a computer-readable recording medium. The computer-readable recording medium is, for example, a non-transitory recording medium, and specifically a magnetic recording device, an optical disc, and the like,

In addition, the program is distributed, for example, by sales, transfer, or lending of a portable recording medium such as a DVD or a CD-ROM on which the program is recorded. Further, the distribution of the program may be performed by storing the program in advance in a storage device of a server computer and transferring the program from the server computer to another computer via a network.

The computer executing such a program first temporarily stores the program recorded in the portable recording medium or the program transferred from the server computer, for example, in an auxiliary recording unit 1050, which is its own non-transitory storage device. Then, when executing processing, the computer reads the program stored in the auxiliary recording unit 1050 serving as its own non-transitory storage device onto the storage unit 1020, and executes processing in accordance with the read program. In addition, as another form of executing the program, the computer may read the program directly from the portable recording medium onto the storage unit 1020, and execute processing in accordance with the program, or further, the computer may sequentially execute processing in accordance with the program received from the server computer every time the program is transferred thereto from the server computer. Furthermore, the processing described above may be executed by a so-called ASP (Application Service Provider) type service, in which processing functions are realized by execution instructions and result acquisition alone, instead of transferring the program to the computer from the server computer. Note that the program in the present form includes information to be used for processing by an electronic computer and equivalent to the program (data which is not a direct command to the computer but has a property that regulates the processing of the computer and the like).

In addition, although the present device is configured by executing the predetermined program on the computer in this from, at least a part of the processing contents may be realized by hardware. For example, the setting unit 2 and the video synthesis unit 3 may be constituted by a processing circuit. In addition, the storage unit 1 may be a memory.

It goes without saying that other changes can be made as appropriate without departing from the gist of the present invention.

### Supplement

The training device may be a training device described below.

The training device includes a memory that stores the video information corresponding to the setting of each video, a processing circuit, and a display that presents the virtual video to the subject.

The processing circuit is configured to (i) set the video setting information that is information for specifying the setting of the video and (ii) use the exercise information of the subject and the video information corresponding to the video setting information read from the memory, and synthesize the virtual video in which the subject is reflected.

In addition, the processing circuit is configured to delay the movement of the subject in the virtual video on the basis of the movement of the line of sight acquired from the sensor attached to the subject.

1. A training device comprising:
a storage unit configured to store video information corresponding to setting of each video;
a setting unit configured to set video setting information that is information for specifying the setting of the video;
a video synthesis unit configured to synthesize virtual video in which a subject is reflected by using exercise information of the subject and the video information corresponding to the video setting information read from the storage unit; and
a video presentation unit configured to present the virtual video to the subject, wherein
the video synthesis unit delays a movement of the subject in the virtual video on the basis of the movement of a line of sight acquired from a sensor attached to the subject.

2. The training device according to claim 1, wherein
the video synthesis unit delays the movement of the subject in the virtual video more greatly as a predetermined threshold value is smaller, when the movement of a line of sight is larger than the predetermined threshold value.

3. The training device according to claim 2, wherein
the predetermined threshold value can be set by a user of the training device.

4. The training device according to claim 1, wherein
the video synthesis unit changes a delay amount of the movement of the subject in the virtual video in accordance with an action of the subject.

5. A training method comprising:
storing video information corresponding to setting of each video in a storage unit;
a setting step of setting, by a setting unit, video setting information that is information for specifying the setting of the video;
a video synthesis step of synthesizing, by a video synthesis unit, virtual video in which a subject is reflected by using exercise information of the subject and the video information corresponding to the video setting information read from the storage unit; and
a video presentation step of presenting, by a video presentation unit, the virtual video to the subject, wherein
the video synthesis unit delays a movement of the subject in the virtual video on the basis of the movement of a line of sight acquired from a sensor attached to the subject.

6. (canceled)

7. The training method according to claim 5, wherein
the movement of the subject in the virtual video is delayed more greatly as a predetermined threshold value is smaller, when the movement of a line of sight is larger than the predetermined threshold value.

8. The training method according to claim 7, wherein
the predetermined threshold value can be set by a user of the training device.

9. The training method according to claim 5, wherein
a delay amount of the movement of the subject in the virtual video is chanced in accordance with an action of the subject.

10. A computer-readable non-transitory recording medium storing computer-executable program instructions that when executed by a processor cause a computer to execute a program generation method comprising:
storing video information corresponding to setting of each video in a storage unit;
a setting step of setting, by a setting unit, video setting information that is information for specifying the setting of the video;
a video synthesis step of synthesizing, by a video synthesis unit, virtual video in which a subject is reflected by using exercise information of the subject and the video information corresponding to the video setting information read from the storage unit; and
a video presentation step of presenting, by a video presentation unit, the virtual video to the subject, wherein
the video synthesis unit delays a movement of the subject in the virtual video on the basis of the movement of a line of sight acquired from a sensor attached to the subject.

11. The program generation method according to claim 10, wherein
the movement of the subject in the virtual video is delayed more greatly as a predetermined threshold value is smaller, when the movement of a line of sight is larger than the predetermined threshold value.

12. The program generation method according to claim 11, wherein
the predetermined threshold value can be set by a user of the training device.

13. The program generation method according to claim 10, wherein
a delay amount of the movement of the subject in the virtual video is chanced in accordance with an action of the subject.

14. The training device according to claim 1, wherein the sensor further comprising a line of sight measurement device.

15. The training device according to claim 1, wherein the movement of the line of sight comprises line of sight trajectories and viewpoint trajectories.

16. The training device according to claim 2, wherein the movement of the line of sight is determined to be greater than the predetermined threshold value when a predictive saccade occurs or the line of sight shifts due to the predictive saccade.

17. The training device according to claim 2, wherein the movement of the line of sight is determined to be greater than the predetermined threshold value when a magnitude of deviation of the line of sight occurs due to a catch-up saccade.

18. The training device according to claim 1, wherein the video synthesis unit delays the movement of the subject in the virtual video based on passage of time.

19. The training device according to claim 1, wherein an image synthesizing unit reduces amount of delay in the movement of the subject in the virtual image as time elapses.

20. The training device according to claim 19, wherein the image synthesizing unit presents the virtual image to the subject by a video presentation unit.

21. The training device according to claim 19, wherein the movement of the subject in the virtual image is increased by the image synthesizing unit based on the movement of the line of sight.
